(19) United States
(12) Patent Application Publication
(10) Pub. No.: US 2026/0330173 A1
(43) Pub. Date: Oct. 22, 2026

(54) RADIO-FREQUENCY IDENTIFICATION (RFID) SYSTEM FOR REAL-TIME TRACKING OF SPORT OBJECTS, AND RFID TAG FOR USE WITH SAME

(71) Applicant: Paul DORLAND, St. Catherines (CA)

(72) Inventor: Paul DORLAND, St. Catherines (CA)

(21) Appl. No.: 19/295,056

(22) Filed: Aug. 8, 2025

Related U.S. Application Data
(63) Continuation-in-part of application No. 19/184,522, filed on Apr. 21, 2025, now abandoned.

(51) Int. Cl. G06K 19/077; G06K 19/07

(52) U.S. Cl. CPC G06K 19/07758; G06K 19/0723; G06K 19/07728; G06K 19/07786

(57) ABSTRACT

A radio-frequency identification (RFID) tag for use with an RFID system for real-time of tracking of a sports object includes: an antenna disposed on a surface of the sports object, where the antenna includes conductive ink and is being sized and configured to interact with signals in the UWB radio frequency range; a RFID microchip connected the antenna; and a protective coating disposed over at least the antenna. The sports object may be, for example, a sporting equipment item comprising a ball, a puck or a tire, or may be a sporting individual wearing a garment.

### CROSS-REFERENCE TO RELATED APPLICATION

This application is a continuation-in-part of U.S. patent application Ser. No. 19/184,522 filed on Apr. 21, 2025, the content of which is incorporated herein by reference in its entirety.

### FIELD

The subject disclosure relates generally to radio-frequency identification (RFID) and in particular, to an RFID system for real-time tracking of sport objects. puck

### BACKGROUND

In the field of athletics, real-time tracking of sports equipment (such as footballs, baseballs, hockey pucks, golf balls, racing vehicles, and the like) is important for both accurate officiating and fan enjoyment. In the case of American football, for example, tracking of the football itself provides support for officiating (such as for first down calls, goal line calls, etc.), performance analytics (such as ball velocity, spin, etc.) and fan enjoyment (such as by providing real-time statistics).

Approaches to live tracking of sports equipment have been implemented. For example, the MotionWorks™ radio-frequency identification (RFID) system developed by Zebra Technologies of Lincolnshire, Illinois, U.S.A., was installed in 18 National Football League (NFL) stadiums during the 2014 season to track vector data. The approach involves embedding RFID tags inside equipment (e.g. footballs) to achieving a ball position accuracy of between 6 to 12 inches, and an uptime of between 50 to 70% uptime in player pile-ups. A version of the system is described in U.S. Pat. No. 8,512,177 to Krysiak et al.

The National Hockey League (NHL) engaged in trials of a system developed by Jogmo World Corp. that used RFID microchips embedded in the interior of hockey pucks. However, signal loss was found to occur under high-speed impacts (namely, around 100 mph) and player coverage. Embedded RFID microchips were observed to face technological challenges, such as: signal attenuation from internal materials (−5-10 dB loss), complex manufacturing, and unreliable performance in occlusion scenarios.

Other approaches to RFID tracking of items unrelated to sports equipment have been described. For example, U.S. Pat. No. 9,256,773 to Finn describes capacitive coupling of an RFID tag with a touch screen device acting as an RFID reader, and methods to produce a capacitive coupling tag. A capacitive coupling tag, which communicates at near field distance with a host computing device by using the touch screen display of the host when the tag is placed on the touch screen or held in contact in close proximity to the touch screen by a person acting as a ground electrode and thereby causing a difference in electrical potential. The capacitive coupling tag operates with or without a chip. In one embodiment, the tag comprises a printed ink electrode.

There is a need for a durable, precise, and versatile tracking solution that integrates with various sports equipment and outperforms existing systems.

Improvements are generally desired. It is object at least to provide a novel RFID system for real-time of tracking of sport objects and to a novel RFID tag for use with same.

### SUMMARY

In one aspect, there is provided a radio-frequency identification (RFID) system for real-time of tracking sport objects, the system comprising: at least one sport object having an RFID tag disposed on an outer surface thereof, the RFID tag comprising an antenna and an RFID microchip connected to the antenna, the antenna comprising conductive ink disposed on a surface of each of said at least one sport object; a plurality of RFID readers configured to transmit signals in the UWB radio frequency range, and to receive returned signals generated and transmitted by the RFID tag; and processing structure in communication with the plurality of transceivers, the processing structure being configured to, at least, process the returned signals for determination of at least one characteristic of the at least one sport object.

The at least one sport object may comprise one or more sporting individuals, each of the one or more sporting individuals wearing a garment defining the surface on which the antenna is disposed.

The at least one sport object may comprise one or more sporting equipment items, each of the one or more sporting equipment items defining the surface on which the antenna is disposed. The at least one sporting equipment item may be one of: a football, a baseball, a soccer ball, a golf ball, and an automotive tire.

The system may be configured to determine the location of the one or more sporting equipment items with an accuracy of about 1.5 cm.

The at least one characteristic may be one or more of: position, velocity, and spin.

In another aspect, there is provided a radio-frequency identification (RFID) tag for use with an RFID system for real-time of tracking of a sports object, the RFID tag comprising: an antenna disposed on a surface of the sports object, the antenna comprising conductive ink and being sized and configured to interact with signals in the UWB radio frequency range; a RFID microchip connected the antenna; and a protective coating disposed over at least the antenna.

The RFID microchip may be disposed on the surface of the at least one sport object, and wherein the protective coating is further disposed over the RFID microchip.

The RFID microchip may be accommodated beneath the surface of the at least one sport object.

The antenna may be disposed on the surface by at least one of: painting, screen-printing, inkjet printing, and three-dimensional (3D) printing.

The conductive ink may comprise conductive particles. The conductive particles may be nanoparticles of copper, silver, gold, carbon black, and combinations thereof. The conductive particles may be nanoflakes of copper, silver, gold, carbon black, and combinations thereof.

The antenna may have a thickness of between about 10 and about 30 μm.

### BRIEF DESCRIPTION OF DRAWINGS

Embodiments will now be described more fully with reference to the accompanying drawings in which:

FIG. 1 is a schematic view of an RFID system for real-time tracking of sport objects;

FIG. 2 is a schematic view of a sporting equipment item for use with the system of FIG. 1;

FIG. 3 is a schematic view of an RFID tag forming part of the sporting equipment item of FIG. 2;

FIG. 4 is a schematic view of a sporting individual for use with the system of FIG. 1;

FIG. 5 is a schematic view of another embodiment of an RFID tag forming part of the sporting equipment item of FIG. 2;

FIG. 6 is a schematic, cross-sectional view of the RFID tag of FIG. 5;

FIG. 7 is a schematic view of another embodiment of an RFID system for real-time tracking of sport objects;

FIG. 8 is a perspective view of another embodiment of a sporting equipment item for use with the system of FIG. 7;

FIG. 9 is a perspective view of still another embodiment of a sporting equipment item for use with the RFID system for real-time tracking of sport objects;

FIG. 10 is a perspective view of yet another embodiment of a sporting equipment item for use with the RFID system for real-time tracking of sport objects;

FIG. 11 is a perspective view of still another embodiment of a sporting equipment item for use with the RFID system for real-time tracking of sport objects; and

FIG. 12 is a front view of still yet another embodiment of a sporting equipment item for use with the RFID system for real-time tracking of sport objects.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art.

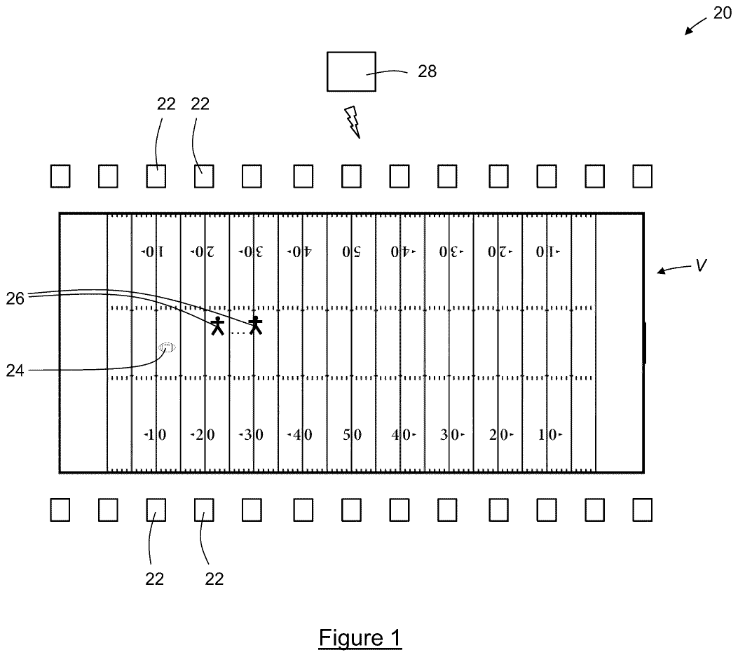

Turning now to FIG. 1, a radio-frequency identification (RFID) system for real-time tracking of sport objects is shown and is generally indicated by reference numeral 20. System 20 comprises a plurality of ultra-wide band (UWB) RFID readers 22 that are positioned in proximity to a sports venue, V, such as for example a ball field, an ice rink, a racing track, a racket sport court, a golf course, and the like. The RFID readers 22 are configured to continuously transmit and receive signals in the UWB radio frequency range for wirelessly tracking the positions of one or more sporting equipment items 24 and one or more sporting individuals 26 in the sports venue V in real time, such as during a sports event taking place at the sports venue V (e.g. a game, a match, a race, and the like). In the example shown, the sports venue V is an american football field, the one or more sporting equipment items 24 is a football, and the one or more sporting individuals 26 are football players and optional football officials, it will be understood that the system 20 is not limited to use with american football fields, footballs, and football players and optional football officials, and in other embodiments the sports venue and/or the one or more sporting equipment items 24 and/or the one or more sporting individuals 26 may be different.

The RFID readers 22 are in communication with processing structure in the form of a general-purpose computing device 28 running an application for real-time tracking of sport objects. The application may be a stand-alone application, or may be a conventional tracking application or system and/or may be integrated with a conventional tracking application or system. The conventional tracking application may be, for example, the MotionWorks™ radio-frequency identification (RFID) system developed by Zebra Technologies of Lincolnshire, Illinois, U.S.A. The general-purpose computing device 28 is configured to control the plurality of RFID readers 22 to continuously i) emit the UWB signals, ii) receive returned signals that are received by the RFID readers 22 and sent by the RFID readers 22 to the general-purpose computing device 28, iii) process the received returned signals to determine characteristics of the one or more sporting equipment items 24 by triangulation, and iv) output the determined characteristics for subsequent processing. The determined characteristics may be any of, but not limited to, position, velocity, spin, etc. The subsequent processing may comprise any of, for example, display of the determined position (or positions) on a representation of a field, broadcast of the determined position (or positions) to viewers, storage of the determined position (or positions) in memory, comparison of the determined position (or positions) to previous determined position (or positions) stored in memory, and the like.

Preferably, the UWB signals emitted by the RFID readers 22 are in the frequency range of 3.1 to 10.6 GHz. As a result of the relatively high frequency range (and hence, relatively short wavelength range) used, the system 20 is able to provide a very high spatial resolution, and is able to determine the location of the one or more sporting equipment items 24 and of the one or more sporting individuals 26 with an accuracy of about 1.5 cm (about 0.6 inches) in non-occluded conditions, or with an accuracy of about 7.5 to about 15 cm (about 3 to about 6 inches) in occluded conditions (e.g. when the one or more sporting equipment items 24 is buried in a player pile-up, a scrum, and the like), and with an uptime (namely, operational status) of about 98 to about 99%.

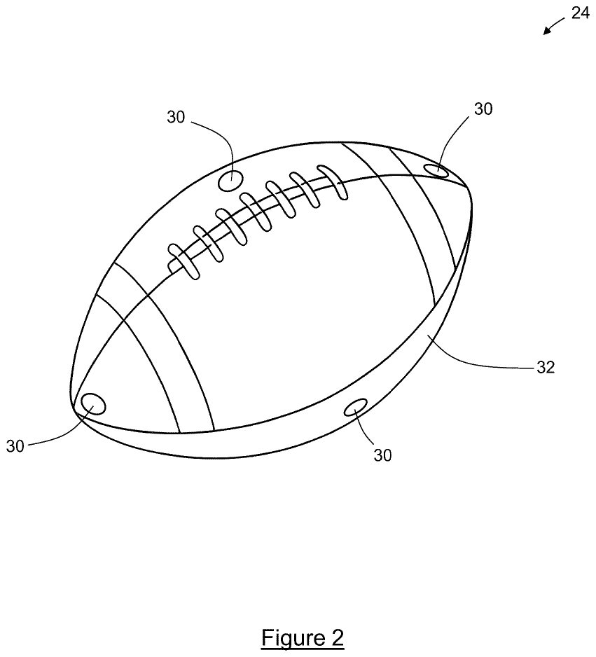

The sporting equipment item 24 may be better seen in FIG. 2. Each of the one or more sporting equipment items 24 has an outer surface on which a plurality of RFID tags 30 are disposed. In the example shown, the sporting equipment item 24 comprises a football 32 having an outer surface on which four (4) RFID tags 30 are disposed. Preferably, the four (4) RFID tags 30 are disposed in a symmetric manner about the axes of symmetry of the football 32, to avoid altering aerodynamics and/or the center of mass of the football 32.

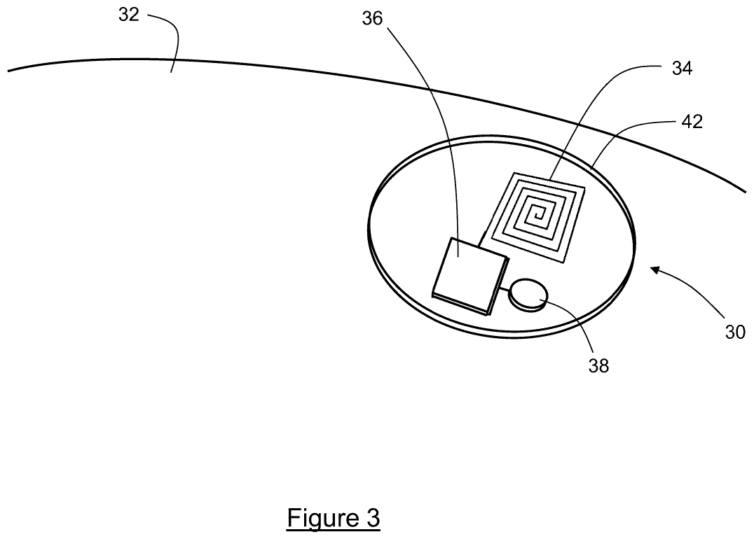

The RFID tag 30 may be better seen in FIG. 3. Each RFID tag 30 comprises an antenna 34 that is sized and shaped to receive the UWB signals emitted by the RFID readers 22, and to provide a pathway for transmission of returned signals for detection by the RFID readers 22. The antenna 34 may be in the form of a spiral pattern, a grid pattern, a fractal pattern, a quasicrystal pattern, a combination thereof, and the like, and is disposed on the surface by any suitable method, such as for example painting, screen-printing, inkjet printing, 3D printing, and the like. The antenna 34 may be formed of a conductive ink, such as for example an ink of conductive particles, such as nanoparticles of copper, silver, gold, carbon black, and the like, and/or nanoflakes of copper, silver, gold, carbon black, and the like, and combinations thereof. The antenna 34 may have a thickness of between about 1 to about 100 μm, preferably between about 5 to about 50 μm, and more preferably between about 10 and about 30 μm. Owing to this thickness range, the antenna 34 is advantageously flexible and can advantageously tolerate flexing and movement of the substrate on which it is disposed (namely, the surface of the football 32) while maintaining its structural integrity. The antenna 34 may be disposed on the surface during manufacture of the sporting equipment item 24 (such as during printing of a brand logo and/or printing of other surface markings), or after manufacture. As one example, the antenna 34 may be overlaid with, or otherwise incorporated into, the brand logo. The antenna 34 may have an area of anywhere from 0.2×0.2 inches to 2×2 inches, depending on the size of the sporting equipment item 24. In the example shown, the antenna 34 disposed on the surface of the football 32 has an area of 2×2 inches.

The RFID tag 30 may further comprise a RFID microchip 36 that is configured for RFID applications and that is electrically connected to the antenna 34. The RFID microchip 36 is in the form of an integrated circuit housed in a suitable packaging, and comprises typical RFID components (not shown) such as a logic unit, memory, and a transceiver. The RFID microchip 36 may be fastened to the surface by any suitable method, such as for example bonding, adhesion, stitching, etc. The RFID microchip 36 is configured to process the UWB signals emitted by the RFID readers 22 received by the antenna 34, generate the returned signals, and transmit the returned signals via the antenna 34. Preferably, the RFID microchip 36 is an active RFID microchip that is connected to an external power source in the form of a battery 38. In one embodiment, the battery 38 may be internal to the RFID microchip 36, such that the battery 38 is accommodated within the packaging of the RFID microchip 36. Alternatively, the RFID microchip 36 may be a passive RFID microchip.

The RFID tag 30 further comprises a protective coating 42 covering the antenna 34, the RFID microchip 36, and the battery 38. The protective coating 42 is fabricated of a durable material, such as a polymer (e.g. polyurethane), a ceramic hybrid, or the like, and may have a thickness in the range of from about 0.05 to about 0.5 mm. The protective coating 42 provides durability to the RFID tag 30, allowing the RFID tag 30 to withstand “gameplay” conditions experienced during use of the sporting equipment item 24. Such “gameplay” conditions may comprise, for example, impacts and adverse weather conditions.

As will be appreciated, positioning the antenna 34 on the outer surface of the sporting equipment item 24 advantageously minimizes signal interference caused by the bulk material of the sporting equipment item 24, and results in a signal loss of only about 1 to about 2 dB, as compared to conventional RFID tag configurations in which the antenna is accommodated in the interior of items. In such conventional configurations, a 5 to 10 dB signal loss typically results from interference (e.g. absorption, external reflection, or internal reflection) of the signal by the bulk material of the sporting equipment item 24.

As will be appreciated, the RFID tag 30 is advantageously lightweight, has a low profile (namely, a negligibly small thickness), has no moving parts, and is robust and durable. Under the protective coating 42, the RFID tag 30 is advantageously able to withstand impact pressures of 1000 psi or greater, velocities of 100 mph or greater, and temperatures of from −20 to 200 degrees Fahrenheit.

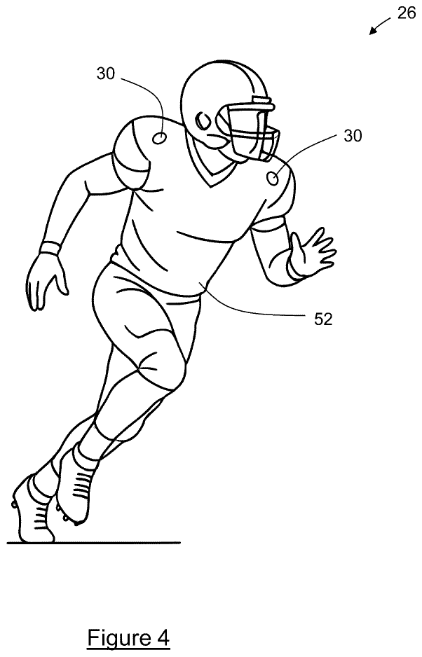

FIG. 4 shows one of the sporting individuals 26. Each of the one or more sporting individuals 26 is wearing clothing in the form of a garment 52, having an outer surface on which a plurality of the RFID tags 30 are disposed. In the example shown, the sporting individual 26 is a football player, and is wearing a garment 52 in the form of a football jersey having an outer surface on which two (2) of the RFID tags 30 are disposed.

In the RFID tag 30 disposed on the garment 52, the antenna 34 is disposed on the surface of the garment 52 by any suitable method, such as for example painting, screen-printing, inkjet printing, 3D printing, and the like, and may be formed of a conductive ink, such as for example an ink of conductive particles, such as nanoparticles of copper, silver, gold, carbon black, and the like, and/or nanoflakes of copper, silver, gold, carbon black, and the like, and combinations thereof. The RFID microchip 36 may be fastened to the surface of the garment 52 by any suitable method, such as for example bonding, adhesion, stitching, etc. The RFID tag 30 further comprises a protective coating 42 covering the antenna 34, the RFID microchip 36, and the battery 38 (when present).

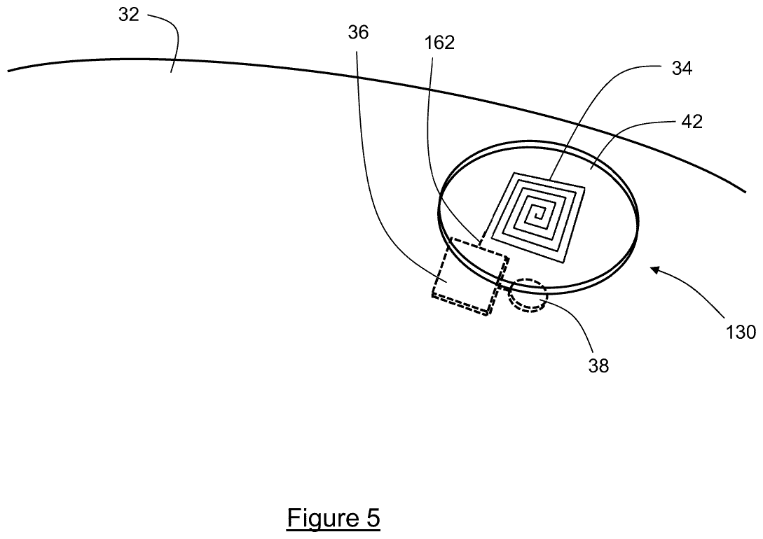

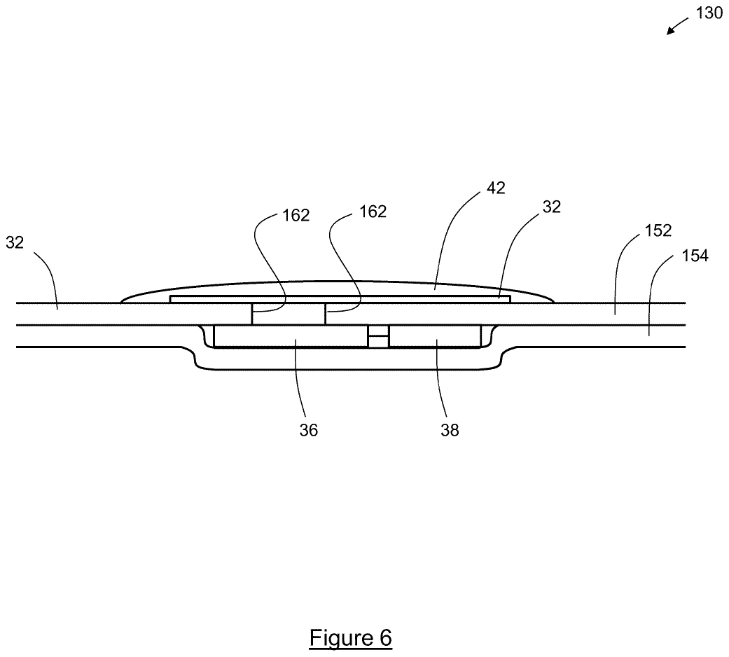

The RFID tag is not limited to the configuration described above, and in other embodiments, other configurations are possible. For example, FIGS. 5 and 6 show another embodiment of an RFID tag for use with the system 20, and which is generally indicated by reference numeral 130. The RFID tag 130 is similar to the RFID tag 30 described above, and comprises the antenna 34, the RFID microchip 36 and the optional battery 38, however only the antenna 34 is disposed on the surface of the sporting equipment item 24 (or on the surface of the garment worn by the sporting individual 26), while the RFID microchip 36 and the optional battery 38 are disposed beneath the surface.

As with RFID tag 30, the antenna 34 of the RFID tag 130 is sized and shaped to receive the UWB signals emitted by the RFID readers 22, and to provide a pathway for transmission of the returned signals for detection by the RFID readers 22. The antenna 34 can be disposed on the surface by any suitable method, such as for example painting, screen-printing, inkjet printing, 3D printing, and the like. The antenna 34 may be formed of a conductive ink, such as for example an ink of conductive particles, such as nanoparticles of copper, silver, gold, carbon black, and the like, and/or nanoflakes of copper, silver, gold, carbon black, and the like, and combinations thereof. The antenna 34 may have a thickness of between about 1 to about 100 μm, preferably between about 5 to about 50 μm, and more preferably between about 10 and about 30 μm. Owing to this thickness range, the antenna 34 is advantageously flexible and can advantageously tolerate flexing and movement of the substrate on which it is disposed (namely, the surface of the football 32) while maintaining its structural integrity. The antenna 34 may be disposed on the surface during manufacture of the sporting equipment item 24 (such as during printing of a brand logo and/or printing of other surface markings), or after manufacture. The antenna 34 may have an area of anywhere from 0.2×0.2 inches to 2×2 inches, depending on the size of the sporting equipment item 24. In the example shown, the antenna 34 disposed on the surface of the football 32 has an area of 2×2 inches.

As with RFID tag 30, the RFID microchip 36 of RFID tag 130 is configured for RFID applications. The RFID microchip 36 is in the form of an integrated circuit housed in a suitable packaging, and comprises typical RFID components (not shown) such as a logic unit, memory, and a transceiver. In this embodiment, the RFID microchip 36 of the RFID tag 130 is disposed between an outer leather portion 152 and an inner bladder 154 of the football 32, and is fastened to the inner surface of the leather portion 152 by any suitable method, such as for example bonding, adhesion, stitching, etc. The RFID microchip 36 is electrically connected to the antenna 34 on the surface of the football 32 by electrical pathways 162 in the form of wires that extend through the thickness of the outer leather portion 152.

The RFID microchip 36 is configured to process the UWB signals emitted by the RFID readers 22 received by the antenna 34, generate the returned signals, and transmit the returned signals via the antenna 34. Preferably, the RFID microchip 36 is an active RFID microchip that is connected to a battery 38, which is also disposed between the outer leather portion 152 and the inner bladder 154 of the football 32. In one embodiment, the battery 38 may be internal to the RFID microchip 36, such that the battery 38 is accommodated within the packaging of the RFID microchip 36. Alternatively, the RFID microchip 36 may be a passive RFID microchip.

The RFID tag 130 further comprises a protective coating 42 covering the antenna 34. The protective coating 42 is fabricated of a durable material, such as a polymer (e.g. polyurethane), a ceramic hybrid, or the like, and may have a thickness in the range of from about 0.05 to about 0.5 mm. The protective coating 42 provides durability to the RFID tag 130, allowing the RFID tag 130 to withstand “gameplay” conditions experienced during use of the sporting equipment item 24. Such “gameplay” conditions may comprise, for example, impacts and adverse weather conditions. As the RFID microchip 36 and the battery 38 (if used) are accommodated beneath the surface of the sporting equipment item 24, the surface area of the protective coating 42 may be smaller in the RFID tag 130, as compared to in the RFID tag 30.

Although not shown, the RFID tab 130 disposed on the garment 52 worn by the sporting individual 26 has a similar configuration, wherein the antenna 34 is disposed on the surface of the garment, and the RFID microchip 36 is disposed on an inner surface of the garment 52, and is fastened thereto by any suitable method, such as for example bonding, adhesion, stitching, etc. Again, preferably, the RFID microchip 36 is an active RFID microchip that is connected to a battery 38, which is also disposed between the outer leather portion 152 and the inner bladder 154 of the football 32. In one embodiment, the battery 38 may be internal to the RFID microchip 36, such that the battery 38 is accommodated within the packaging of the RFID microchip 36. Alternatively, the RFID microchip 36 may be a passive RFID microchip.

In the RFID tag 130 disposed on the garment 52, the antenna 34 is disposed on the surface of the garment 52 by any suitable method, such as for example painting, screen-printing, inkjet printing, 3D printing, and the like, and may be formed of a conductive ink, such as for example an ink of conductive particles, such as nanoparticles of copper, silver, gold, carbon black, and the like, and/or nanoflakes of copper, silver, gold, carbon black, and the like, and combinations thereof. The RFID tag 130 further comprises a protective coating 42 covering the antenna 34.

As will be appreciated, positioning the antenna 34 on the outer surface of the sporting equipment item 24, or on the outer surface of the garment 52 worn by the sporting individual 26, advantageously minimizes signal interference caused by the bulk material of the sporting equipment item 24, and results in a signal loss of only about 1 to about 2 dB, as compared to conventional RFID tag configurations in which the antenna is accommodated in the interior of items. In such conventional configurations, a 5 to 10 dB signal loss typically results from interference (e.g. absorption, external reflection, or internal reflection) of the signal by the bulk material of the sporting equipment item 24 or of the garment 52 worn by the sporting individual 26.

As will be appreciated, the RFID tag 130 is advantageously lightweight, has a low profile (namely, a negligibly small thickness), has no moving parts, and is robust and durable. Under the protective coating 42, the RFID tag 130 is advantageously able to withstand impact pressures of 1000 psi or greater, velocities of 100 mph or greater, and temperatures of from −20 to 200 degrees Fahrenheit.

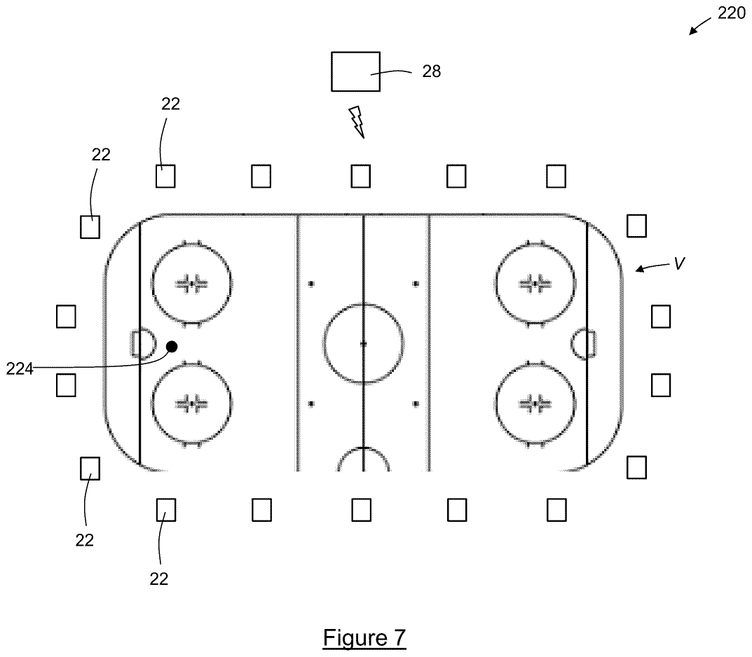

The system is not limited to the embodiment described above, and in other embodiments, other configurations are possible. For example, FIG. 7 shows another embodiment of a radio-frequency identification (RFID) system for real-time tracking of sport objects, which is generally indicated by reference numeral 120. System 120 is similar to system 20 described above and with reference to FIGS. 1 to 6, and comprises the plurality of ultra-wide band (UWB) radio frequency RFID readers 22 that are positioned in proximity to a sports venue, V. The RFID readers 22 are configured to continuously transmit signals in the UWB radio frequency range for wirelessly tracking the position of one or more sporting equipment items 224 and one or more sporting individuals (not shown) in the sports venue V in real time, such as during a sports event taking place at the sports venue V. In the example shown, the sports venue V is an ice hockey rink, and the one or more sporting equipment items 224 is a hockey puck.

The RFID readers 22 are in communication with processing structure in the form of the general-purpose computing device 28 running an application for real-time tracking of sport objects. The general-purpose computing device 28 is configured to control the plurality of RFID readers 22 to continuously i) emit the UWB signals, ii) receive returned signals that are received by the RFID readers 22 and returned to the general-purpose computing device 28, iii) process the received returned signals to determine characteristics of the one or more sporting equipment items 224 by triangulation, and iv) output the determined characteristics for subsequent processing. The determined characteristics may be any of, but not limited to, position, velocity, spin, etc. The subsequent processing may comprise any of, for example, display of the determined position (or positions) on a representation of a field, broadcast of the determined position (or positions) to viewers, storage of the determined position (or positions) in memory, comparison of the determined position (or positions) to previous determined position (or positions) stored in memory, and the like.

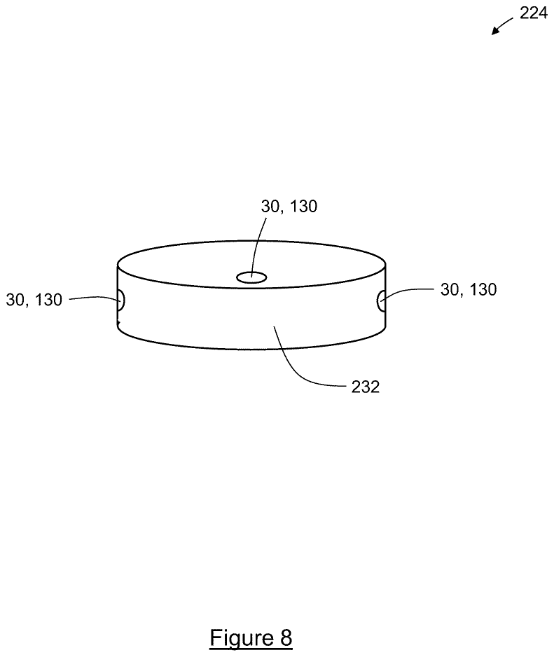

The sporting equipment item 224 may be better seen in FIG. 8. Each of the one or more sporting equipment item 224 comprises a plurality of the above-described RFID tags 30 or 130 that are disposed on the outer surface thereof. In the example shown, the sporting equipment item 224 comprises four (4) RFID tags 30 or 130 disposed on a surface of the hockey puck 232, with one (1) of the RFID tags 30 or 130 being disposed on a bottom surface of the hockey puck 232 and therefore being not visible. In the example shown, the antenna 34 forming part of each RFID tag 30 or 130 disposed on the sporting equipment item 224 has an area of 1×1 inches. Preferably, the four (4) RFID tags 30 or 130 are disposed in a symmetric manner about the axes of symmetry of the hockey puck 232, to avoid altering aerodynamics and/or the center of mass of the hockey puck 232.

In the case where the RFID tags disposed on the sporting equipment item 224 are the RFID tags 130, the antenna 34 is disposed on the surface of the hockey puck 232, and the RFID microchip 36 is embedded in the interior of the hockey puck 232, such as during the molding step in the manufacture of the hockey puck 232. Preferably, the RFID microchip 36 is an active RFID microchip that is connected to a battery 38, which is also embedded in the interior of the hockey puck 232. In one embodiment, the battery 38 may be internal to the RFID microchip 36, such that the battery 38 is accommodated within the packaging of the RFID microchip 36. Alternatively, the RFID microchip 36 may be a passive RFID microchip. The RFID tag 130 further comprises a protective coating 42 covering the antenna 34.

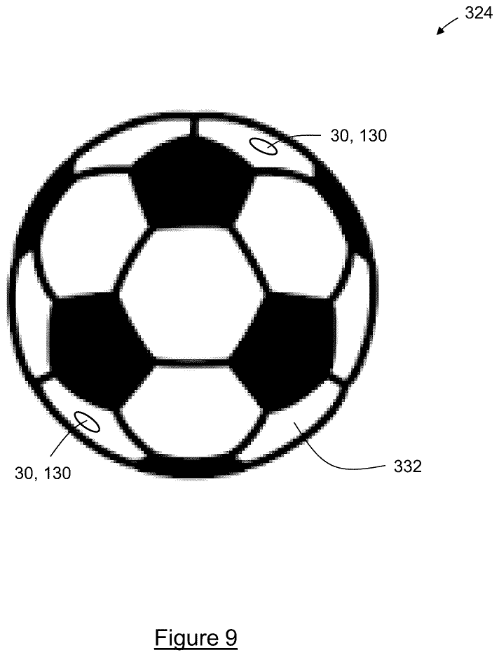

Still other embodiments are contemplated. For example, FIG. 9 shows another example of a sporting equipment item 324 that may be used with the radio-frequency identification (RFID) system for real-time tracking of sport objects of the present invention. The sporting equipment item 324 is in the form of a soccer ball, and comprises a plurality of the above-described RFID tags 30 or 130 that are disposed on the outer surface thereof. In the example shown, the sporting equipment item 324 comprises two (2) RFID tags 30 or 130 disposed on a surface of the soccer ball 332. Preferably, the two (2) RFID tags 30 or 130 are disposed in a symmetric manner about the axes of symmetry of the soccer ball 332, to avoid altering aerodynamics and/or the center of mass of the soccer ball 332.

In the case where the RFID tags disposed on the sporting equipment item 324 are the RFID tags 130, the antenna 34 is disposed on the surface of the soccer ball 332, and the RFID microchip 36 is disposed between an outer leather portion (not shown) and an inner bladder (not shown) of the soccer ball 332, and is fastened to the inner surface of the leather portion by any suitable method, such as for example bonding, adhesion, stitching, etc. The RFID microchip 36 is electrically connected to the antenna 34 on the surface of the soccer ball 332 by electrical pathways (not shown) in the form of wires that extend through the thickness of the outer leather portion. Preferably, the RFID microchip 36 is an active RFID microchip that is connected to a battery 38, which is also fastened to the inner surface of the leather portion of the soccer ball 332. In one embodiment, the battery 38 may be internal to the RFID microchip 36, such that the battery 38 is accommodated within the packaging of the RFID microchip 36. Alternatively, the RFID microchip 36 may be a passive RFID microchip. The RFID tag 130 further comprises a protective coating 42 covering the antenna 34.

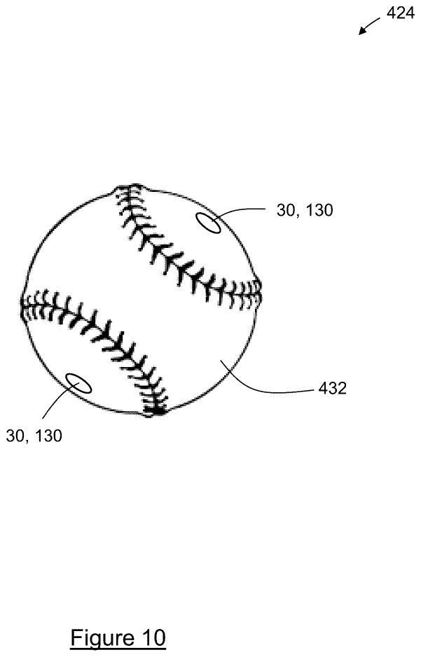

FIG. 10 shows another example of a sporting equipment item 424 that may be used with the radio-frequency identification (RFID) system for real-time tracking of sport objects of the present invention. The sporting equipment item 424 is in the form of a baseball, and comprises a plurality of the above-described RFID tags 30 or 130 that are disposed on the outer surface thereof. In the example shown, the sporting equipment item 424 comprises two (2) RFID tags 30 or 130 disposed on a surface of the baseball 432. Preferably, the two (2) RFID tags 30 or 130 are disposed in a symmetric manner about the axes of symmetry of the baseball 432, to avoid altering aerodynamics and/or the center of mass of the baseball 432.

In the case where the RFID tags disposed on the sporting equipment item 424 are the RFID tags 130, the antenna 34 is disposed on the surface of the baseball 432, and the RFID microchip 36 is disposed underneath an outer leather portion of the baseball 432, and is fastened to the inner surface of the leather portion by any suitable method, such as for example bonding, adhesion, stitching, etc. The RFID microchip 36 is electrically connected to the antenna 34 on the surface of the baseball 432 by electrical pathways (not shown) in the form of wires that extend through the thickness of the outer leather portion. Preferably, the RFID microchip 36 is an active RFID microchip that is connected to a battery 38, which is also fastened to the inner surface of the leather portion of the baseball 432. In one embodiment, the battery 38 may be internal to the RFID microchip 36, such that the battery 38 is accommodated within the packaging of the RFID microchip 36. Alternatively, the RFID microchip 36 may be a passive RFID microchip. The RFID tag 130 further comprises a protective coating 42 covering the antenna 34.

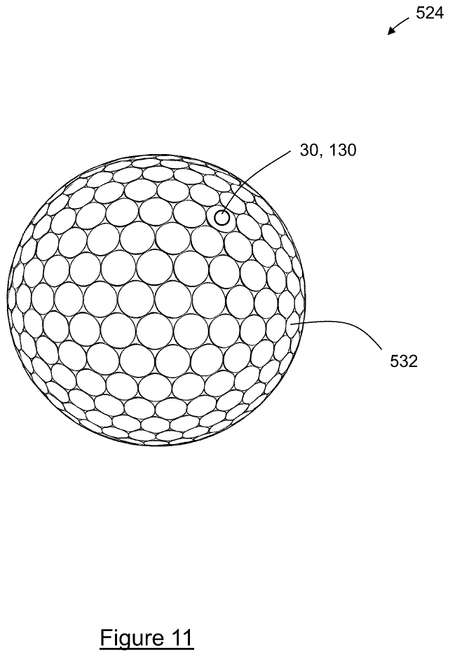

FIG. 11 shows another example of a sporting equipment item 524 that may be used with the radio-frequency identification (RFID) system for real-time tracking of sport objects of the present invention. The sporting equipment item 524 is in the form of a golf ball, and comprises at least one of the above-described RFID tags 30 or 130 that is disposed on the outer surface thereof. In the example shown, the sporting equipment item 524 comprises only one (1) RFID tag 30 or 130 disposed on a surface of the golf ball 532. In the example shown, the antenna 34 forming part of the RFID tag 30 or 130 disposed on the sporting equipment item 524 has an area of 0.2×0.2 inches.

In the case where the RFID tag disposed on the sporting equipment item 524 is the RFID tags 130, the antenna 34 is disposed on the surface of the golf ball 532, and the RFID microchip 36 is microchip 36 is embedded in the interior of the golf ball 532, such as during a molding step in the manufacture of the golf ball 532. The RFID microchip 36 is electrically connected to the antenna 34 on the surface of the golf ball 532 by electrical pathways (not shown) in the form of wires that extend through the thickness of an outermost layer of the golf ball 532 (such as a urethane layer or skin). Preferably, the RFID microchip 36 is an active RFID microchip that is connected to a battery 38, which is embedded in the interior of the golf ball 532. In one embodiment, the battery 38 may be internal to the RFID microchip 36, such that the battery 38 is accommodated within the packaging of the RFID microchip 36. Alternatively, the RFID microchip 36 may be a passive RFID microchip. The RFID tag 130 further comprises a protective coating 42 covering the antenna 34.

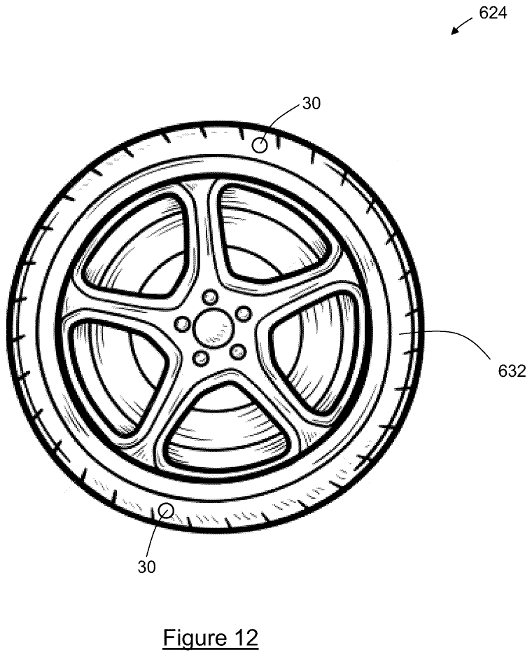

FIG. 12 shows another example of a sporting equipment item 624 that may be used with the radio-frequency identification (RFID) system for real-time tracking of sport objects of the present invention. The sporting equipment item 624 is in the form of an automotive racing wheel comprising a tire, and comprises a plurality of the above-described RFID tags 30 that are disposed on the outer surface thereof. In the example shown, the sporting equipment item 624 comprises two (2) RFID tags 30 disposed on a surface of the tire 632. Preferably, the two (2) RFID tags 30 are disposed in a symmetric manner about the axes of symmetry of tire 632, to avoid altering the center of mass of tire 632.

Although embodiments have been described above with reference to the accompanying drawings, those of skill in the art will appreciate that variations and modifications may be made without departing from the scope thereof as defined by the appended claims.

What is claimed is:

1. A radio-frequency identification (RFID) system for real-time of tracking sport objects, the system comprising:
at least one sport object having an RFID tag disposed on an outer surface thereof, the RFID tag comprising an antenna and an RFID microchip connected to the antenna, the antenna comprising conductive ink disposed on a surface of each of said at least one sport object;
a plurality of RFID readers configured to transmit signals in the UWB radio frequency range, and to receive returned signals generated and transmitted by the RFID tag; and
processing structure in communication with the plurality of transceivers, the processing structure being configured to, at least, process the returned signals for determination of at least one characteristic of the at least one sport object.

2. The system of claim 1, wherein the at least one sport object comprises one or more sporting individuals, each of the one or more sporting individuals wearing a garment defining the surface on which the antenna is disposed.

3. The system of claim 1, wherein the at least one sport object comprises one or more sporting equipment items, each of the one or more sporting equipment items defining the surface on which the antenna is disposed.

4. The system of claim 3, wherein the at least one sporting equipment item is one of: a football, a baseball, a soccer ball, a golf ball, and an automotive tire.

5. The system of claim 1, wherein the system is configured to determine the location of the one or more sporting equipment items with an accuracy of about 1.5 cm.

6. The system of claim 1, wherein the at least one characteristic is one or more of: position, velocity, and spin.

7. A radio-frequency identification (RFID) tag for use with an RFID system for real-time of tracking of a sports object, the RFID tag comprising:
an antenna disposed on a surface of the sports object, the antenna comprising conductive ink and being sized and configured to interact with signals in the UWB radio frequency range;
a RFID microchip connected the antenna; and
a protective coating disposed over at least the antenna.

8. The RFID tag of claim 7, wherein the at least one sport object comprises one or more sporting individuals, each of the one or more sporting individuals wearing a garment defining the surface on which the antenna is disposed.

9. The RFID tag of claim 7, wherein the at least one sport object comprises one or more sporting equipment items, each of the one or more sporting equipment items defining the surface on which the antenna is disposed.

10. The RFID tag of claim 9, wherein the at least one sporting equipment item is one of: a football, a baseball, a soccer ball, a golf ball, and an automotive tire.

11. The RFID tag of claim 7, wherein the RFID microchip is disposed on the surface of the at least one sport object, and wherein the protective coating is further disposed over the RFID microchip.

12. The RFID tag of claim 7, wherein the RFID microchip is accommodated beneath the surface of the at least one sport object.

13. The RFID tag of claim 7, wherein the antenna is disposed on the surface by at least one of: painting, screen-printing, inkjet printing, and three-dimensional (3D) printing.

14. The RFID tag of claim 7, wherein the conductive ink comprises conductive particles.

15. The RFID tag of claim 14, wherein the conductive particles are nanoparticles of copper, silver, gold, carbon black, and combinations thereof.

16. The RFID tag of claim 14, wherein the conductive particles are nanoflakes of copper, silver, gold, carbon black, and combinations thereof.

17. The RFID tag of claim 7, wherein the antenna has a thickness of between about 10 and about 30 μm.
